(19) United States
(12) Patent Application Publication
(10) Pub. No.: US 2005/0120992 A1
(43) Pub. Date: Jun. 9, 2005

(54) Cylinder head of a reciprocating piston internal combustion engine

(76) Inventors: Ulrich Rieger, Stuttgart (DE); Manfred Ester, Stuttgart (DE)

Correspondence Address: KLAUS J. BACH, 4407 TWIN OAKS DRIVE, MURRYSVILLE, PA, 15668, US

(21) Appl. No.: 11/010,838

(22) Filed: Dec. 13, 2004

Related U.S. Application Data
(63) Continuation-in-part of application No. PCT/EP03/04438, filed on Apr. 29, 2003.

(30) Foreign Application Priority Data
Jun. 15, 2002 (DE) 102 26 688.3

(51) Int. Cl. F02F 1/00

(52) U.S. Cl. 123/193.5

(57) ABSTRACT

In a cylinder head of an internal combustion engine a pivot lever frame is provided for the cylinder head(s) of the engine, which frame is mounted on a cylinder head lower part and on which a cylinder head cover is disposed. The pivot lever frame is fitted with pivot lever shafts supporting pivot levers and extends in one piece over several cylinder heads

This is a continuation-in-part application of international application PCT/EP03/04438 filed Apr. 29, 2003, and claiming the priority of German application 102 26 688.3 filed Jun. 15, 2002.

### BACKGROUND OF THE INVENTION

The invention relates to a reciprocating piston internal combustion engine having a cylinder head with a cylinder head cover and a shaft supported on the cylinder head for controlling the intake gas flow to, and the exhaust gas flow from, the cylinder of the engine.

DE 195 04 637 C2 discloses a cylinder head of an internal combustion engine having a device for supporting a camshaft and a pivot lever shaft. This device is mounted approximately in the center above the cylinder head and extends from the first cylinder to the last cylinder. A cylinder head cover covers the device and is attached to the cylinder head in a sealed fashion. The device is a relatively narrow component which is fitted only with pivot lever shafts and the camshaft.

DE 198 45 942 A1, U.S. Pat. No. 5,150,675, U.S. Pat. No. 4,823,747, EP 0 890 713 A2, U.S. Pat. No. 3,672,338, and U.S. Pat. No. 4,572,117 each disclose a cylinder head of a liquid cooled internal combustion engine in the form of a block-like cylinder head and an attachment on the cylinder head. The attachment terminates the cylinder head in the upward direction and is itself covered by a cylinder head cover. In addition, the attachment contains a shaft or axle for controlling the gas change of the cylinders.

Furthermore, DE-A-25 02 058 discloses an internal combustion engine which has a plurality of individual cylinder heads on which a camshaft housing, which extends over all the individual cylinder heads, is arranged. This camshaft housing is attached only to two individual cylinder heads, while on the other individual cylinder heads a gap remains between the camshaft housing and the individual cylinder heads.

Finally, U.S. Pat. No. 4,459,947 discloses an internal combustion engine which also has a plurality of individual cylinder heads on which a housing that extends over all the individual cylinder heads is arranged in order to support a camshaft in conjunction with an inlet manifold.

It is the object of the present invention to provide a cylinder head having a device for supporting a shaft of a gas exchange control device, which device is inherently rigid, reinforces the cylinder head and is simple to mount on the individual cylinder heads of a multi-cylinder internal combustion engine.

### SUMMARY OF THE INVENTION

In a cylinder head of an internal combustion engine a pivot lever frame is provided for the cylinder heads of the engine, which frame is mounted on a cylinder head lower part and onto which a cylinder head cover is fitted. The pivot lever frame is fitted with tilting lever shafts and tilting levers and extends in one piece over several cylinder heads.

This device is embodied as a single-piece frame and is mounted on the cylinder head lower parts. In order to prevent loss of oil to the surroundings, a seal, for example, a fluid seal, is inserted between the pivot lever frame and the cylinder head lower parts. The cylinder head having the frame is covered with a cylinder head cover which is also provided with a seal and is fitted onto the frame. As a result of the frame being supported on the plurality of individual cylinder heads over a large area, the frame is inherently very rigid and reinforces the entire cylinder head assembly as it is bolted to the cylinder head lower parts.

A shaft can be pre-mounted separately on the frame, which simplifies the manufacturing process on an assembly line. In this way, the individual cylinder heads are inter-connected at their upper ends by means of the rigid frame whereby the entire cylinder head assembly becomes more sturdy. A further advantage is the significantly simpler mounting of all the components which are pre-assembled for the individual cylinder heads of a row of cylinders, in contrast to a plurality of individual frames which are each mounted on an individual cylinder head.

In a particular embodiment of the invention, a shaft which is mounted in the frame above the cylinder head lower part is a pivot lever or drag lever shaft or axle. In one embodiment of the internal combustion engine with a lower camshaft which activates tappet rods and with gas exchange valves in the cylinder head, the movement of the tappet rods is generally reversed by means of pivot levers. These pivot levers pivot on a shaft which is supported according to the invention in the frame mounted on the cylinder head lower part.

In a further refinement of the invention, the frame includes a structure for supplying lubricating oil to elements of the gas exchange control arrangement. By means of prefabricated, cast or bored lines or passages in the frame it is easily possible to supply lubricating oil supply to all the points to be lubricated in the valve drive such as, for example, levers or drag levers, hydraulic valve-play-compensating elements or hydraulically activated switching elements for influencing the timing. When the lubricating oil flows are distributed inside the frame it is possible for the cylinder head lower part, either of a block cylinder head design or individual cylinder head design, to be made simpler and thus more cost effective since only one oil transfer point into the frame has to be provided.

Preferably, the frame includes means for controlling valves of an engine brake. When an internal combustion engine is used in utility vehicles, the engine is often provided with an engine brake, i.e. each cylinder of the internal combustion engine has a valve which opens prematurely, for example, at the end of the compression stroke, so that the compression work expended in the internal combustion engine is wasted as hot air and the internal combustion engine and the vehicle are braked. Such a valve is, for example, actuated hydraulically in a direct fashion or by a mechanical activating mechanism. In this context, according to the invention hydraulic pressurized fluid supply passages which are necessary are integrated in the frame above the cylinder head lower parts. These passages or ducts are cast or formed into the frame. When the passages or ducts are integrated into the frame, the expenditure of mounting is considerably simplified. In an integrated passage, no sealing points at connections which are costly to manufacture and seals are not needed.

In a further refinement of the invention, a fuel low-pressure passage is integrated into the frame. By integrating a fuel low-pressure passage into the frame, the expenditure on mounting is further reduced. Furthermore, since only one fuel line has to be routed to the cylinder head and since the distribution to the fuel injectors of the individual cylinders takes place inside the frame, only a relatively low degree of structural complexity is necessary and the risk of leakage in the fuel system, particularly at line connections, is reduced. This integrated fuel line may be used either as a fuel supply flow or as a fuel return flow passage, or, in a combined version, it can be used a fuel supply flow and return flow passage.

In a further refinement of the invention, the frame has connectors for fuel injectors. By directly screwing a fuel injector onto the frame, the need for an additional fuel line is avoided and the fuel injector is rigidly connected to the cylinder head without additional securing means. In this way, a means of securing the injector and of supplying fuel which his reliable in terms of mounting and operation is made provided.

In still a further refinement of the invention, a high-pressure line for controlling the fuel injection is integrated into the frame. If the fuel injector is not activated by a camshaft by means of levers and similar transmission elements but is instead actuated for example with high pressure oil, this high-pressure line for the oil is advantageously integrated into the frame in order to prevent high-pressure lines becoming mixed up during assembly.

Preferably the frame includes means for venting the cooling system of the internal combustion engine. In one embodiment of the internal combustion engine with individual cylinder heads, a frame above the individual cylinder heads with a venting facility is particularly advantageous because individual cylinder heads do not have a continuous water core which passes through all the cylinders. For this reason, each individual cylinder head must have, at its geodetically highest point, a means of venting the coolant system, i.e. ports with lines, for example, to a coolant means equalizing vessel. In an embodiment with a frame which covers all the cylinders it is advantageous to provide an overflow point for the coolant into a coolant duct in the frame in each individual cylinder head. Since the frame generally is at a geodetically higher position than the cylinder head lower part, only one venting means has to be provided in the coolant duct in the frame. In this way, the expenditure on parts and mounting for venting the coolant system in the cylinder head is considerably reduced. At the same time, the operational reliability is significantly increased by virtue of fewer lines and line connections.

In a further particular embodiment of the invention, the bearing of the pivot lever shaft or of the camshaft is a bush-type bearing. The frame retains its rigidity and the bearing support structure can easily be manufactured.

The invention will become more readily apparent from the following description of exemplary embodiments thereof described below with reference to the accompanying drawings.

### BRIEF DESCRIPTION OF THE DRAWINGS

FIG. 1 is a perspective view of a frame according to the invention for supporting pivot lever shaft for a cylinder head.

FIG. 2 is a perspective view of the frame shown in FIG. 1 with pivot levers and pivot lever shafts installed in the frame, and

FIG. 3 shows the frame mounted on the cylinder heads and covered by the cylinder head cover.

### DESCRIPTION OF PREFERRED EMBODIMENTS

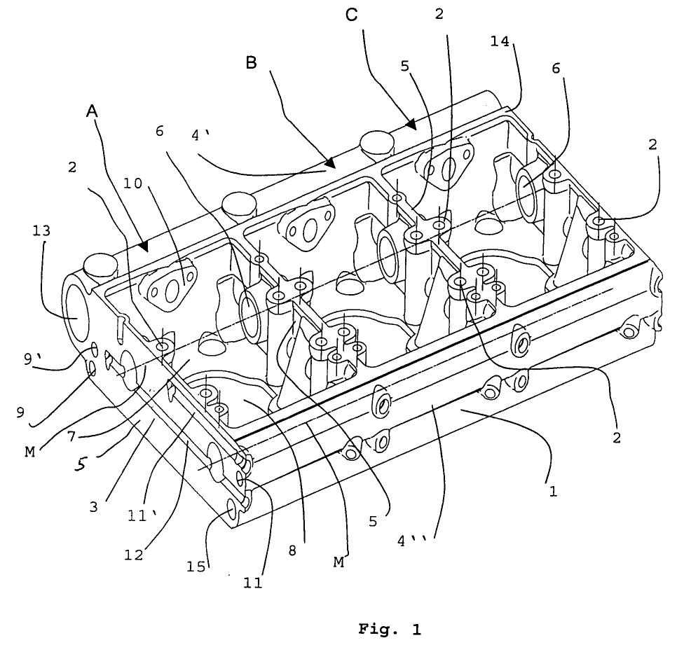

FIG. 1 is a perspective view of a frame 1 according the invention for supporting pivot lever shafts on a plurality of individual cylinder heads 20, 21, 22 (FIG. 3) of a multi-cylinder reciprocating piston engine. The frame 1 covers a plurality of individual cylinder heads 20, 21, 22 onto which it is screwed at the screw eyelets 2. For the sake of better illustration, the frame 1 is shown in a sectional form that is cut along a plane 3 between two cylinders. The section of the frame which is shown in FIG. 1 covers three cylinder heads of the reciprocating piston engine and accordingly includes three frame parts A, B, C.

The frame 1 comprises two outer walls 4′, 4″ extending along the longitudinal sides, which walls are each joined along planes 3 between two cylinders by means of transverse webs 5. The screw eyelets 2 and the bearings 6 for the pivot lever shafts which are only indicated by means of their center axes M, are arranged on these transverse webs 5.

The center axes M of the pivot lever shafts (not shown in FIG. 1) extend along either side of the frame 1 over its entire length. The frame 1 also has a base 7 which additionally reinforces the frame and is partially interrupted in order to form passages 8 for valve control elements (not shown) such as, for example, tappets, pivot levers and valves. The base 7 is located on the upper side of the cylinder heads 20-22 and is sealed off from the outside by fluid seals or a form seals arranged between the frame 1 and the cylinder head.

In one outer wall 4′ of the longitudinal side, a fuel supply passage 9 and a fuel return flow passage 9′, which have flow connections to connectors 10 for fuel injectors (not shown), extend over the entire length. In this way, it is not necessary to mount separate fuel lines to each fuel injector, allowing the fuel circulation system to be implemented in a simpler, more cost effective and more operationally reliable way which is also facilitates assembly. The same applies to hydraulic lines 11, 11′ which are integrated into the frame 1 and which are used to actuate additional, hydraulically activated valves of a motor brake arrangement.

The lubrication points of the valve drive (not shown) are supplied via a lubricating oil supply line 12 in the transverse webs 5.

In an outer wall 4′ on the longitudinal side, an integrated high-pressure fuel duct 13, which is used to supply high-pressure fuel to electrically activated fuel injectors, extends over the entire length.

The cylinder head cover 19 is disposed on the upper connecting face area 14 of the frame, with a seal disposed between the cylinder head cover 19 and the frame preventing leakage toward the outside.

A channel 15 for venting the cooling system, which duct has at each cylinder a flow connection to the geodetically highest point of the water space of the cylinder head and thus of the entire cylinder, extends over the entire length of the frame in the outer wall 4″ on the longitudinal side. In this way, a reliable and particularly a simple and cost effective method, which is friendly in terms of mounting, for venting the coolant system of the internal combustion engine in the cylinder head is obtained both for a cylinder block 18 and the cylinder heads 20-22 for an embodiment with individual cylinder heads.

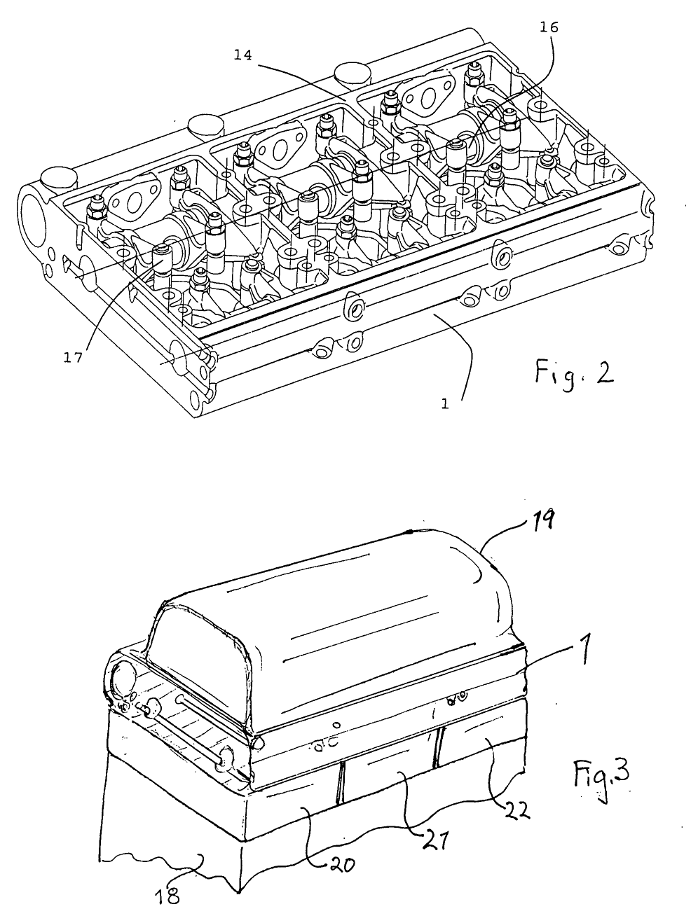

FIG. 2 shows the frame 1 of FIG. 1 in a perspective view in a partially assembled state with pivot lever shafts 16 and pivot levers 17. Such a frame 1 is assembled separately and mounted onto the cylinder head(s) as one complete unit with the addition of a seal. In this way, pre-mounting assembly outside the actual engine assembly line is possible, which provides for advantages in terms of logistics and manufacturing. After the pre-assembled frame 1 has been mounted, the fuel injectors (not shown) are screwed into the connectors 10 and the cylinder head cover 19 is attached to the top face 14 of the frame 1.

FIG. 3 shows the assembled engine block 18, cylinder heads 20-22 and cylinder head cover 19.

1. A cylinder head of a reciprocating piston internal combustion engine having
a cylinder head lower part (20, 21, 22),
a frame (1) for supporting a shaft of a gas exchange control mechanism, and
a cylinder head cover (19) disposed on said frame (1), said frame (1) being mounted on the cylinder head lower part (20, 21, 22) onto which the cylinder head cover (19) is fitted, said engine including individual cylinder head lower parts (20, 21, 22) with said frame (1) extending over several of the individual cylinder lower parts (20, 21, 22), said frame (1) comprising two outer walls on the longitudinal sides thereof, which walls are interconnected between two cylinders by transverse webs (5) and a pivot shaft (16) supported in bearings mounted in said transverse webs (5).

2. The cylinder head as claimed in claim 1, wherein the frame (1) includes means (12) for supplying lubricating oil to elements of the gas exchange control mechanism.

3. The cylinder head as claimed in claim 1, wherein the frame (1) includes means (11, 11′) for controlling valves of an engine brake mechanism.

4. The cylinder head as claimed in claim 1, wherein a fuel supply and fuel return passage (9, 9′) are integrated into the frame (1).

5. The cylinder head as claimed in claim 1, wherein the frame (1) has a connector (10) for mounting a fuel injector.

6. The cylinder head as claimed in claim 5, wherein a high pressure fuel supply line (13) for the fuel injection is integrated into the frame (1).

7. The cylinder head as claimed in claim 1, wherein the frame (1) includes means (15) for venting the cooling system of the internal combustion engine.
